(19) United States
(12) Patent Application Publication
(10) Pub. No.: US 2005/0096076 A1
(43) Pub. Date: May 5, 2005

(54) Method for closed-loop power control in a communication system

(75) Inventors: Jian Gu, Huangqi Nanhai Guangdong (CN); Seppo Hamalainen, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/746,343

(22) Filed: Dec. 29, 2003

(30) Foreign Application Priority Data
Oct. 30, 2003 (FI) 20031582

(51) Int. Cl. H04Q 7/20

(52) U.S. Cl. 455/522; 455/69

(57) ABSTRACT

A method for closed-loop power control between stations in a wireless communication system is described. The method comprises providing a channel between stations, the channel being divided in slots for carrying data symbols. The method further comprises inserting power control symbols carrying information associated with one power control command in at least two slots. In an embodiment, the method may further comprise operating the channel in discontinuous mode of operation.

### FIELD OF THE INVENTION

The invention relates to communication systems, and more particularly to power control in a wireless communication system.

### BACKGROUND OF THE INVENTION

Wireless communication systems include various cellular or otherwise mobile communication systems using radio frequencies for sending voice or data between stations, such as mobile stations (MS) and base transceiver stations (BTS).

FIG. 1 shows an example of a wireless communication system where a mobile station 1 is connected over the radio path with a base transceiver station 2, also called a base station. Typically, a certain number of base transceiver stations 2, 3, 4 may be controlled by a base station controller (BSC) 5 and these entities together may form a base station sub-system (BSS). An area of service of a base transceiver station 2 is referred to as a cell 6. There may be several cells related to one base transceiver station. It shall be appreciated that FIG. 1 is only an example of a simplified wireless communication system showing one mobile station, five base transceiver stations and that the number and type of these entities may differ substantially from the shown.

All mobile stations in a cell of a cellular system may use the same radio resource, i.e. frequency range assigned to the system, over which the data may be carried over the air interface between the respective mobile stations and the base station. The frequency range is subdivided into radio channels, which may include traffic and control channels. Control channels may include broadcast channels (BCH), common control channels (CCCH) and dedicated control channels (DCCH). On a broadcast channel the base station may transmit continuous information, such as frequency correction, frame synchronization or cell-specific information, jointly to the mobiles. Common control channels may be used for access to the network, for example for paging. Dedicated control channels may be used to carry signaling messages and information from higher protocol layers, such as service and control information.

A channel carrying information from a base station to a mobile station, i.e. on the downlink, may be called as a forward link and, respectively, a channel carrying information from a mobile station to a base station, i.e. on the uplink, may be called as a reverse link. The forward and reverse links may advantageously exploit frequency ranges that are sufficiently separated from each other to allow simultaneous transmission and reception without feedback or interference from the transmitter into the receiver. This is called duplex separation.

Traffic and control channels, so-called logical channels, may be mapped onto physical channels using different techniques. Examples of the basic access techniques include frequency division multiple access (FDMA), time division multiple access (TDMA), code division multiple access (CDMA), or space division multiple access (SDMA). The actual communication standards typically employ one or more of these in the provision of wireless communication services. Wideband code division multiple access (WCDMA), enhanced data rates for global evolution (EDGE) and code division multiple access 2000 (CDMA2000) are examples of channel multiplexing technologies, which may be used in the so-called third generation (3G) mobile communication systems. An example of the 3G systems is the universal mobile telecommunication system (UMTS) terrestrial radio access (UTRA).

Mobile stations in a cell are typically capable of transmitting and receiving over the entire frequency band assigned to the cell. For example, in the CDMA systems, the signal to be transmitted is spread on data symbols i.e. multiplied by a specified spreading code assigned to the subscriber, whereby the transmission spreads out onto the frequency band. The spreading code determines a traffic channel for each mobile station. Therefore, the mobile stations in the cell share the same radio resource and also the power of the resource.

In the mobile communication system, the signal may be interfered or attenuated by different factors, such as path loss, shadow fading and Rayleigh fading. Typically, the total attenuation of the received signal is a combination of a number of attenuation factors.

Rayleigh fading is caused by simultaneous reception of several signals at the receiver. Several signals may have been produced by reflection from objects in the vicinity. They thus have different distances to travel and they may arrive from different directions to the receive antenna. Therefore, the signals are typically out of phase with one another when they reach the receive antenna. Additionally, the transmitter may move and thus the phase difference varies. Thereby, the signals may be sometimes reinforced and sometimes counteracted with each other.

Consequently, the signal transmit power typically needs to be controlled in the wireless communication system. Power control may be carried out normally at a base station or at a mobile station or at both of them by adjusting the transmit power based on power control signal or commands, such as power control bits for example on a dedicated control channel. Usually, power control is used for maintaining the quality of the received signal at a desired level using as low power level as possible. If the signal quality falls below the desired level, the transmit power may be adjusted. Power control may improve the system capacity, reduce interferences between stations and compensate fading on the radio path.

Because of the duplex separation, multipath fading on the forward and reverse channels are independent from each other. A mobile station cannot measure the path loss of the reverse link directly and therefore assumes that there is the same path loss as on the forward link. However, the Rayleigh fading causes independent fading effects, as explained above. Some mobile communication systems perform closed-loop power control (CL PC). In the CL PC, the base station carries out the power control in concert with the mobile station, to overcome negative effects caused by fading.

In the CL PC, a cell demodulator in the cell site, for example in a base station, may measure the received signal-to-noise ratio from a mobile station. The measured signal-to-noise ratio may be compared to the desired signal-to-noise ratio for the mobile station in question and a power control command may be sent to the mobile station in the forward channel addressed to that mobile station. In the CL PC, the transmit power of a mobile station may thereby be controlled both by its own measurements and by the power control command from the cell site, such as from the base station.

Similar power control may be performed also in the base station. The base station may receive power control commands from the mobile station. The base station may adjust its transmit power based on the power control commands from the mobile station and on base station's own measurements.

A closed-loop power control circuitry may include a circuitry for selectively deriving the power control command responsive to measurements of signal-to-noise ratio of the received signal. The power control command may signal the mobile station to increase or decrease the transmit power by a predetermined value, for example 0.5 dB. The power control frequency may typically be once every 1.25 ms.

The effect of closed-loop power control in a station may be evaluated by the ratio of the combined received energy per information bit (E_{b}) to the effective noise power spectral density (Nₜ), or E_{b}/Nₜ. Also, the ratio between the combined received pilot energy accumulated over one pseudonoise (PN) chip period (E_{c}) to the intra-cell interference power spectral density in the received bandwith (Iₒᵣ) may be used to evaluate the closed-loop power control.

In the closed-loop power control, the power control symbols or bits are usually time-multiplexed, that is periodically embedded, or I/Q-multiplexed with the dedicated channels. Because of this the power control symbols may use resources even without transmitting any information data. In wireless communication systems with closed-loop power control, the selection of power control frequency and the resource occupied by power control symbols is thus considered as an important task.

Lots of mobile communication systems, including those based on the WCDMA and CDMA2000, support discontinuous transmission (DTX), for example gated transmission. The discontinuous transmission is a mode of operation in which a base station or a mobile station switches its transmitter or a particular code channel on and off autonomously. In the gated transmission the mobile communication system is switched on and off during specific power control groups. The aim of the discontinuous transmission is to reduce the interference to other users keeping at the same time the quality of the connection at a desired level. Different systems may adopt different schemes for the discontinuous transmission. For example, in the CDMA2000 system, the power control frequency can be changed and, in the WCDMA, relative power allocated for the control channel can be changed during the discontinuous transmission.

A prior art method wherein power control commands are embedded in a dedicated channel is illustrated in FIG. 2. In the CDMA2000 systems for example, the reverse power control sub-channel may be embedded in the reverse dedicated pilot channel. The power control symbols carrying information regarding one power control command are inserted in one slot of the reverse dedicated pilot channel. The reverse dedicated pilot channel may support half rate and quarter rate discontinuous transmission. When the reverse dedicated pilot channels with power control commands embedded inside are in discontinuous transmission, the frequency of forward closed-loop power control reduces. When the reverse dedicated pilot channel changes from the full rate transmission to the half gated rate transmission and from the half gated rate transmission to the quarter gated rate transmission, the forward power control frequency reduces to half and quarter, respectively. The frequency reduction may cause higher transmit power to meet the performance of a single link and, thus, may degrade the system performance.

Therefore, the prior art method in the CDMA2000 system does not provide a satisfactory performance of the systems where the reverse dedicated pilot channels are in gated transmission. The CDMA2000 system may employ a so-called Forward Fundamental Channel, which is a portion of a forward traffic channel carrying a combination of higher-level data and power control information, and a so-called Forward Supplemental Channel operating in conjunction with the Forward Fundamental Channel. Furthermore, the CDMA200 system may employ a Reverse Fundamental Channel, which is a portion of a reverse traffic channel carrying higher-level data and control information from a mobile station to a base station, and a Reverse Supplemental Channel operating in conjunction with the Reverse Fundamental Channel. The gated mode of the reverse dedicated pilot channel is typically used when none of these channels is assigned. When neither the Forward Fundamental Channel nor the Forward Supplemental Channel is assigned, a forward dedicated control channel may be assigned and needs closed-loop power control. Similar problems may occur in other systems.

Therefore, it may be desired to improve the system performance when a channel adapted to carry the power control commands is in discontinuous mode. It may be desired to improve the system performance by being able to increase the frequency of the closed-loop power control in discontinuous or gated mode.

### SUMMARY OF THE INVENTION

Embodiments of the invention aim to address one or several of the above problems or issues.

In accordance with an aspect of the invention, there is provided a method for closed-loop power control between stations in a wireless communication system, the method comprising providing a channel between stations, the channel being divided in slots for carrying data symbols, inserting power control symbols carrying information associated with one power control command in at least two slots. In certain embodiments, the channel may be operated in discontinuous mode of operation.

In accordance with another aspect of the invention, there is provided a wireless communication system comprising a channel provided between stations, the channel being divided in slots for carrying data symbols, and means for inserting power control symbols carrying information associated with one power control command associated with a given slot in at least two slots. In certain embodiments, the channel may be capable of operating in discontinuous mode of operation.

In certain embodiments, the discontinuous mode of operation may comprise gated mode. In certain embodiments, the gated mode may be even ½^{m} gated transmission (m=0, 1, 2, . . . ) and the power control symbols are preferably inserted in two consecutive slots. In certain further embodiments, the gated mode may be even 1/g^{m} gated transmission (g=3, 4, 5, . . . , and m=0, 1, 2, . . . ). In such a case, the power control symbols may be inserted in two slots or in g slots, preferably in two consecutive slots or in g consecutive slots.

The embodiments of the invention may enhance the performance of wireless communication systems, in particular when using discontinuous transmission in the dedicated channels. Particular advantage may be expected in the performance of forward channels, whose power is controlled by power control bits in reverse dedicated pilot channels, when the reverse dedicated pilot channels are in gated mode of operation.

### BRIEF DESCRIPTION OF FIGURES

The invention will now be described in further detail, by way of example only, with reference to the following examples and accompanying drawings, in which:

FIG. 1 shows an example of a wireless communication system in which the embodiments of the invention may be implemented.

FIG. 2 shows an example of a prior art method for transmitting power control bits in reverse dedicated pilot channels at different gating rates.

FIG. 3 shows an example of a scheme for transmitting power control bits in reverse dedicated pilot channels at different gating rates in accordance with an embodiment of the invention.

FIG. 4 presents an example of the bit error rates (BER) of the power control bits over Rayleigh fading channels.

FIG. 5 presents the frame error rate (FER) of an existing scheme and of an embodiment of the invention.

FIG. 6 presents the FER of an existing scheme and of a further embodiment of the invention.

FIG. 7 presents the FER of an existing scheme and of a further embodiment of the invention.

FIG. 8 presents the FER of an existing scheme and of a further embodiment of the invention.

FIG. 9 presents the FER of an existing scheme and of a further embodiment of the invention.

FIG. 10 presents the FER of an existing scheme and of a further embodiment of the invention.

FIG. 11 presents the FER of an existing scheme and of a further embodiment of the invention.

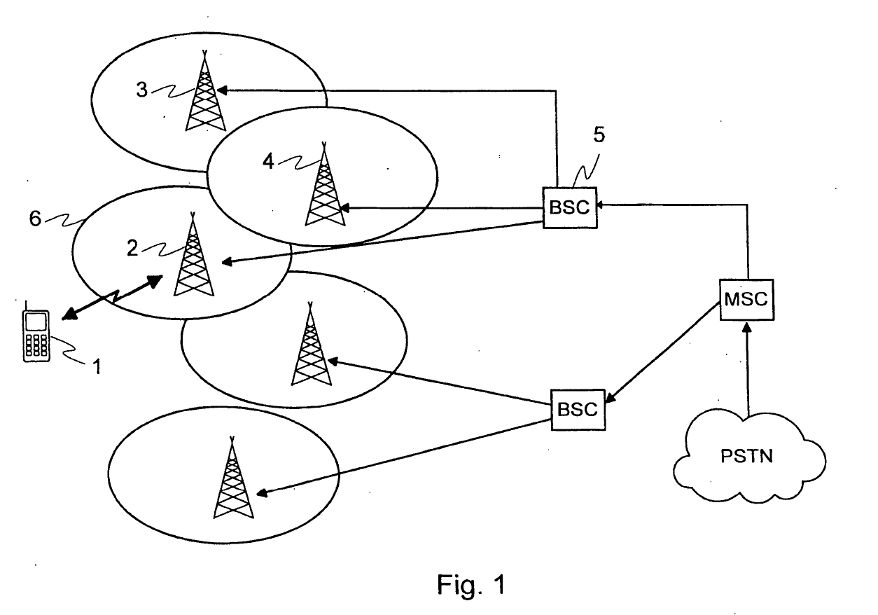

### DETAILED DESCRIPTION OF THE PREFERRED EMBODIMENTS

The herein described embodiment of the invention provides a method for closed-loop power control for applications wherein the channel with power control bits may be operated in discontinuous mode. The system performance may be improved by increasing the power control frequency.

The invention provides improvements in particular in the forward link when the reverse dedicated pilot channel is in discontinuous mode. FIGS. 5-11, which show results for simulations performed in the CDMA2000 forward link, illustrate this improvement.

In the preferred embodiment, the closed-loop power control is performed between stations in a wireless communication system, wherein a channel provided between stations is divided in slots for carrying data symbols and may be operated in discontinuous mode of operation. The power control frequency of the discontinuous operation in the preferred embodiment may be increased by inserting the power control symbols carrying information regarding one power control command in at least two slots. This means that, instead of repeating the power control symbols in the same slot, the power control symbols are repeated in at least one other slot.

In this specification, terms discontinuous mode and gated mode are both referring to a mode of operation, where the transmitter or a channel may be switched on and off at a base station or at a mobile station. The switching may be based on certain conditions and/or rules for switching. If the channel with the power control symbols is in the discontinuous or gated mode, the minimum discontinuous or gated transmission unit is a slot. A frame is typically divided into multiple slots.

A station sending power control command in a mobile communication system may, in an embodiment, insert in a slot multiple power control symbols that carry k different power control commands. At the same time, power control symbols that carry a power control command for a given slot can be inserted in n slots. In this embodiment, both k and n are a positive integer.

When the channel with the power control symbols is continuous, a station receiving the commands may then combine the power control symbols that represent the same power control command and are inserted in the n slots after the receiver receives all the power control symbols in the n slots. In the continuous operation, the power control frequency may be kept the same as that in the prior art systems, for example every 1.25 ms.

When the channel with the power control symbols is in discontinuous mode, after the receiving station has received the power control commands, the receiving station may use the power control commands that are made available for it to adjust the transmit power of the transmitter in the opposite link, i.e. in the link towards the station sending the commands. The power control frequency depends on the factors k, n and the gating rate.

In the following, an embodiment employing even ½^{m} gated transmission (m=0, 1, 2, . . . ) is illustrated in more detail. In the illustrated embodiment, the power control symbols representing the same power control command are inserted in two consecutive slots. In a further embodiment, the power control symbols may also be inserted in more than two slots.

In a further embodiment, the communication system may operate in other gating rates. For example, if the channel with the power control symbols operated in 1/g^{m} rate gated mode, where g is a non-negative integer greater than or equal to 3 and m is a non-negative integer, the power control symbols representing the same power control command may be inserted in at least two slots. Alternatively, the power control symbols representing the same power control command may be inserted in g slots. For example, when the gating rate is ⅓, the power control symbols representing the same power control command may be inserted in 3 slots. In certain embodiments, it is preferred that the power control symbols representing one power control command are inserted in consecutive slots. In certain embodiments, the power control symbols representing one power control command may be inserted in other than consecutive slots.

In the following, an embodiment of reverse link dedicated pilot channel that may operate in gating rates is illustrated in more detail. In a further embodiment, the power control symbols may also be inserted in more than two slots of other dedicated channels (both forward link and reverse link).

In a further embodiment, the power control symbols may also be inserted in any positions of slots other than the beginnings and the ends of slots.

FIG. 3 illustrates in more detail an embodiment of the invention. The communication system may be arranged to operate in accordance with even ½^{m} (m=0, 1, 2, . . . ) gated transmission, where m is a non-negative integer. The gating rate may thus be, for example, 1 (continuous), ½, ¼etc. The power control symbols associated with a first power control command may be inserted, respectively, both in the end of the slot number 0 and in the beginning of the slot number 1. The same may be done for a second power control command, which correspondingly may be inserted both in the end of the slot number 1 and in the beginning of the slot number 2.

In the embodiment illustrated in FIG. 3, the number of slots containing the power control symbols associated with one power control command (n) is 2. Furthermore, in the embodiment illustrated in FIG. 3, the number of different power control commands inserted in one slot (k) is 2. Furthermore, in the embodiment illustrated in FIG. 3, the power control symbols are inserted in the beginning and in the end of the slots. These selections are made for illustrative purposes only. As disclosed above, the number and location of power control symbols associated with one power control command as well as the number of different power control commands inserted in one slot may be selected depending on the desired power control frequency and the gating rate.

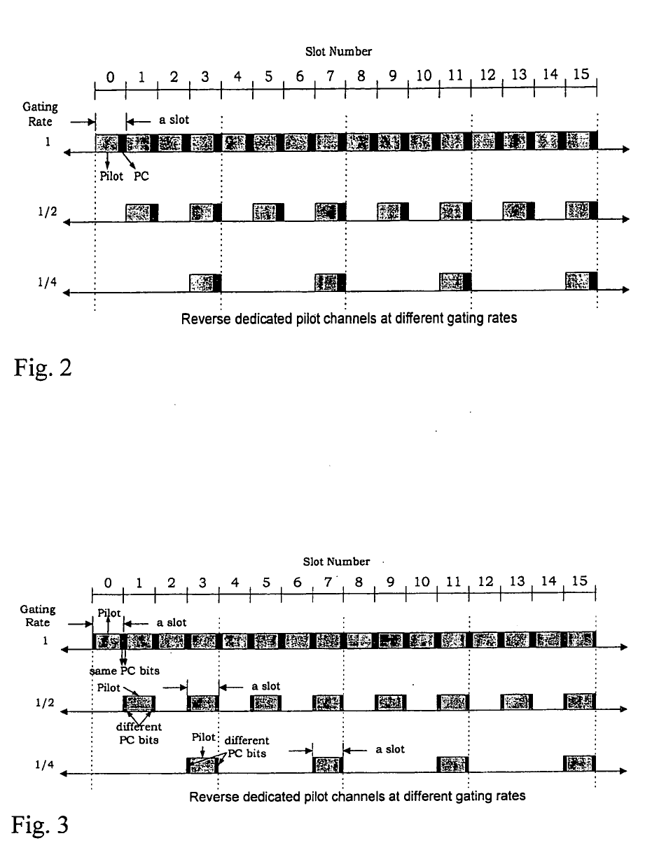

Compared with the prior art method illustrated in FIG. 2, the embodiment of FIG. 3 provides an increased frequency of closed-loop power control when the channel with the power control symbols is in the gated mode. When the channel with the power control symbols is in continuous transmission, the normal frequency may be maintained in the embodiment illustrated in FIG. 3. The increase of closed-loop power control frequency in the gated mode brings lower Eₒ/Iₒ (the ratio between the pilot energy accumulated over one PN chip period (E_{c}) to the total power spectral density (Iₒ) in the received bandwidth) target of dedicated channels and lowers their transmit power, thus improving the system performance.

In the two schemes illustrated FIGS. 2 and 3, the duration fractions of the power control symbols in the pilot channel and the powers of the pilot channel are the same. From FIGS. 2 and 3, it is clear that the performance is substantially the same in the two schemes for continuous transmission.

However, the performances of the two schemes differ in the gated transmission mode. The differences between the two schemes of FIGS. 2 and 3 are listed in Table 1 below.

TABLE 1
Comparison between the prior art method of FIG. 2 and the
embodiment of FIG. 3 in gated mode of transmission.

| | | Embodiment of |
|---|---|---|
| | Prior art method | the invention |
| | (FIG. 2) | (FIG. 3) |
| PC frequency | f/2 for half gating | f for half gating |
| | f/4 for quarter gating | f/2 for quarter gating |
| PC symbols duration | T_{c} | T_{c}/2 |
| Eb/Nt for PC bits (linear) | E_{b}/Nₜ | (E_{b}/Nₜ)/2 |

In Table 1, PC is power control, f is the maximum PC frequency, T_{c} is the PC symbol duration in the existing scheme and E_{b}/Nₜ is the average linear Eb/Nt (ratio of the combined received energy of an information bit to the effective noise power spectral density for PC bits).

Increasing the frequency of the closed-loop power control is believed to bring the bit error rate (BER) degradation to the power control bits. The BER degradation of power control bits in certain embodiments is analyzed below from numerical values.

The raw BER of the power control bits (P_{b}) over single-path Rayleigh fading channel may be given by the following formula (1):

$${P}_{b} = ( 1 - \frac{1}{\sqrt{1 + \frac{1}{2 \frac{{E}_{b}}{{N}_{t}}}}} ) / 2 \qquad ( 1 )$$

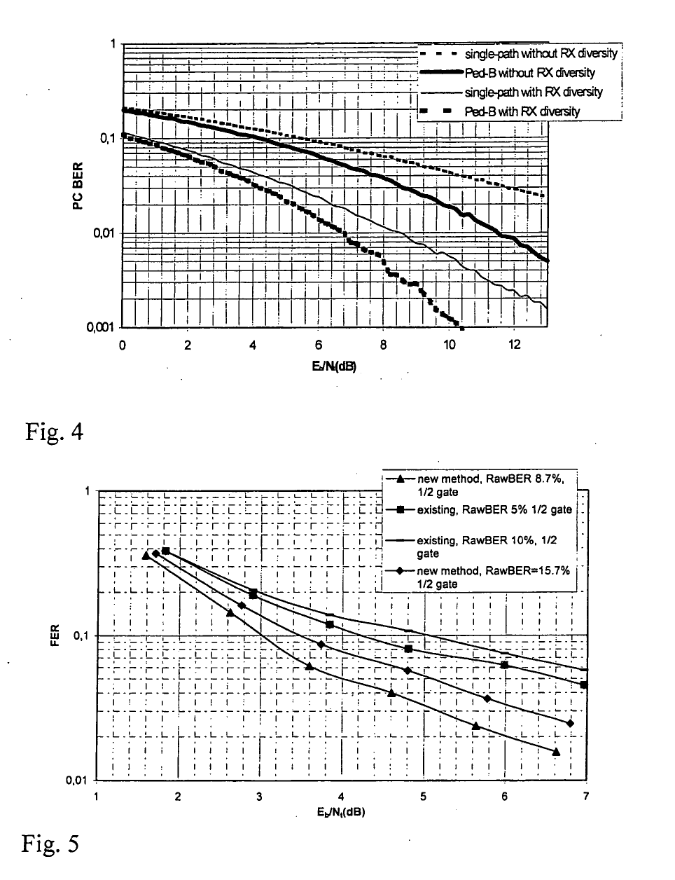

Some numerical results are shown in FIG. 4 and listed below:

When E_{b}/Nₜ=9.30 dB, P_{b}=0.05 on single-path fading channel without Receive (RX) diversity.

When E_{b}/Nₜ=6.30 dB, P_{b}=0.087 on single-path fading channel without Receive (RX) diversity.

When E_{b}/Nₜ=5.50 dB, P_{b}=0.1 on single-path fading channel without Receive (RX) diversity.

When E_{b}/Nₜ=3.50 dB, P_{b}=0.157 on single-path fading channel without Receive (RX) diversity.

When E_{b}/Nₜ=6.90 dB, P_{b}=0.05 on Pedestrian B fading channel without Receive (RX) diversity.

When E_{b}/Nₜ=3.90 dB, P_{b}=0.106 on Pedestrian B fading channel without Receive (RX) diversity.

When E_{b}/Nₜ=3.50 dB, P_{b}=0.05 on single-path fading channel with Receive (RX) diversity.

When E_{b}/Nₜ=1.50 dB, P_{b}=0.106 on single-path fading channel with Receive (RX) diversity.

When E_{b}/Nₜ=3.00 dB, P_{b}=0.05 on Pedestrian B fading channel without Receive (RX) diversity.

When E_{b}/Nₜ=0.00 dB, P_{b}=0.112 on Pedestrian B fading channel without Receive (RX) diversity.

The method of the present invention does not affect the system performance when the channel with the power control symbols is in continuous transmission. Compared with the prior art, this invention increases the frequency in which the closed-loop power control is operated when the channel with the power control symbols is in discontinuous transmission mode. This may improve the performance of the whole system. Under the condition of invariant power of the channels with the power control sub-channels and invariant duration fraction of the power control sub-channels in the dedicated channels which the power control sub-channels are embedded in, the increase of closed-loop power control frequency reduces the E_{b}/Nₜ of power control bits, thus increasing the BER of the power control bits. However, the research shows that the improvement brought by the increased power control frequency is more beneficial than the degradation brought by the increased BER of the increased frequency of power control bits.

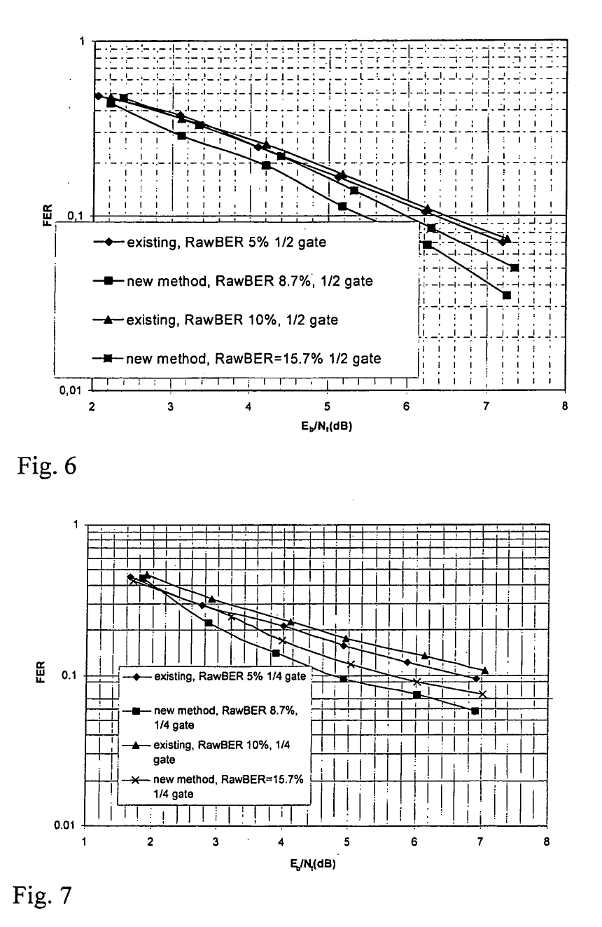

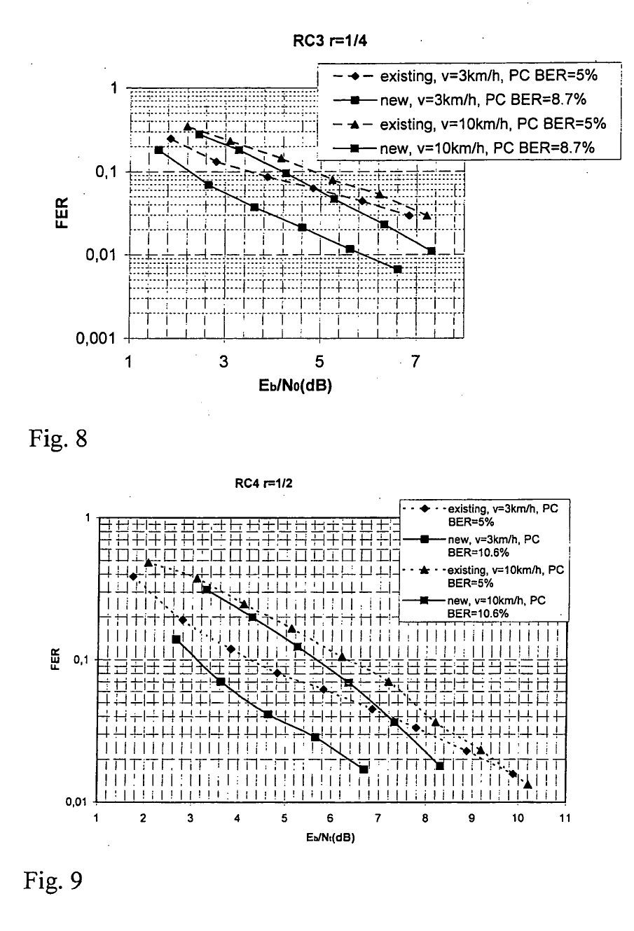

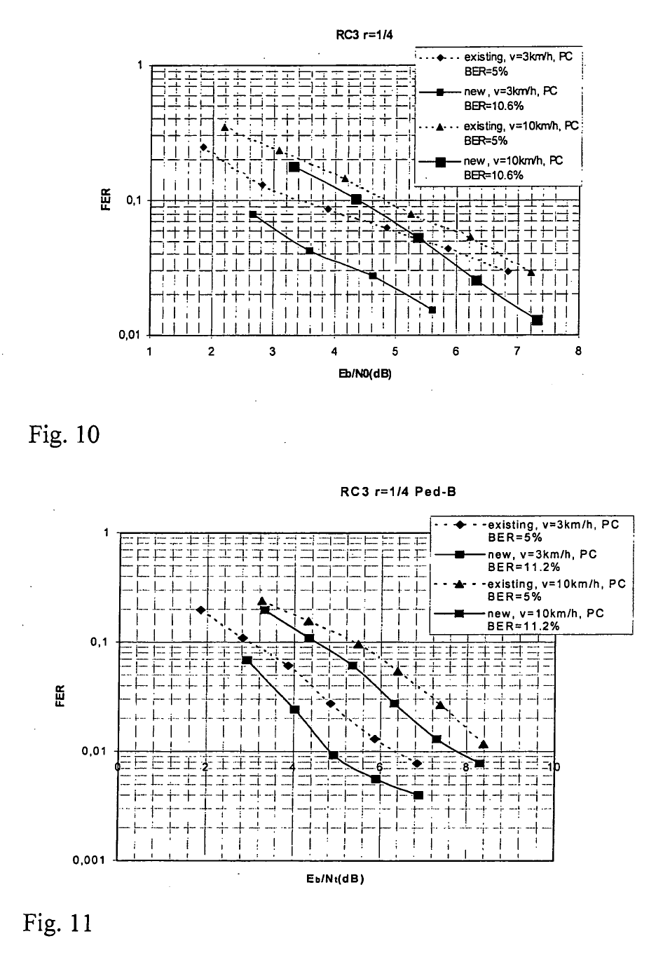

FIGS. 5-11 show, in the way of simulation results, the improvement that may be expected by embodiments of the invention in different wireless communication environments. The simulation environments were the following:
FIG. 5: Radio Configuration RC4, 9.6 kbps, single-path Rayleigh fading channels, mobile station velocity v=3 km/h, different PC BERs, half gate mode.
FIG. 6: RC4, 9.6 kbps, single-path Rayleigh fading channels, v=10 km/h, different PC BERs, half gate mode.
FIG. 7: RC4, 9.6 kbps, single-path Rayleigh fading channels, v=3 km/h, different PC BERs, quarter gate mode.
FIG. 8: RC3, 9.6 kbps, single-path Rayleigh fading channels, v=3 km/h and 10 km/h, different PC BERs, half gate mode.
FIG. 9: RC4, 9.6 kbps, single-path Rayleigh fading channels, two receive antennae, v=3 km/h and 10 km/h, different PC BERs, half gate mode.
FIG. 10: RC3, 9.6 kbps, single-path Rayleigh fading channels, two receive antennae, v=3 km/h and 10 km/h, different PC BERs, half gate mode.
FIG. 11: RC3, 9.6 kbps, multi-path pedestrian-B fading channels, two receive antennae, v=3 km/h and 10 km/h, different PC BERs, half gate mode.

From the simulation results shown in FIGS. 5-11, it can be concluded that a substantial gain in power control frequency may be obtained in the simulated cases, such as with and without reverse link receiving diversity, radio configuration RC3 and RC4, single-path and multi-path fading channels.

The savings and gains attained by the method of the invention might be evaluated also based on the ratio between the pilot energy accumulated over one pseudonoise chip period to the intra-cell interference power spectral density in the received bandwidth. The relationship between E_{c}/Iₒᵣ and E_{b}/Nₜ is given by

$$\begin{matrix}{E}_{c} / {I}_{or} = \frac{{E}_{c}}{{I}_{oc} + {I}_{or} \cdot ( 1 - η )} \cdot \frac{{I}_{oc} + {I}_{or} \cdot ( 1 - η )}{{I}_{or}} \\ = {E}_{c} / {I}_{0} \cdot ( \frac{1}{Geometry} + 1 - η ) \\ = {E}_{b} / {N}_{t} \cdot ( \frac{1}{PG \cdot Geometry} + \frac{1 - η}{PG} )\end{matrix}$$

where η is the orthogonality factor and PG is the processing gain. Given a multi-path fading channel, η is fixed. Therefore, the gain in E_{c}/Iₒᵣ is the same as that in E_{b}/Nₜ.

The bursty packet service volume in wireless communication is believed to increase. Thus it can be expected that the discontinuous or gated transmission plays a more important role in supporting users, especially Non-Real-Time data users. The embodiments may improve the performance of users in discontinuous transmission, which contributes more performance improvement to the whole system with more Non-Real-Time packet service volume. The embodiments are fairly easy to implement in the systems. The transmitters of existing systems may need only slight modifications in the software thereof.

Although the invention has been described in the context of particular embodiments, various modifications are possible without departing from the scope and spirit of the invention as defined by the appended claims. For example, the communication system wherein the invention may be implemented may be any communication system in which the power control frequency decreases when the station is in discontinuous transmission, besides code division multiple access. In certain cases, it may be advantageous to implement the invention in both forward link dedicated channels and reverse link dedicated channels. In certain cases, it may be advantageous to insert the power control symbols carrying information associated with one power control command in other slots than the consecutive slots, even if insertion in consecutive slots may often be preferred.

1. A method for closed-loop power control between stations in a wireless communication system, the method comprising:
providing a channel between stations, the channel being divided in slots for carrying data symbols; and
inserting power control symbols carrying information associated with one power control command in at least two slots.

2. The method according to claim 1, further comprising:
operating the channel in a discontinuous mode of operation.

3. The method according to claim 1, wherein the inserting step comprises inserting the power control symbols in consecutive slots.

4. The method according to claim 2, wherein the operating step comprises operating the channel in the discontinuous mode of operation comprising a gated mode.

5. The method according to claim 4, wherein the operating step comprises operating the gated mode in an even ½^{m} gated transmission, where m is a non-negative integer.

6. The method according to claim 5, wherein the inserting step comprises inserting the power control symbols in two slots.

7. The method according to claim 4, wherein the operating step comprises operating the gated mode in an even 1/g^{m} gated transmission, where g is a non-negative integer greater than or equal to 3 and m is a non-negative integer.

8. The method according to claim 7, wherein the inserting step comprises inserting the power control symbols in two slots.

9. The method according to claim 7, wherein the inserting step comprises inserting the power control symbols in g slots.

10. The method according to claim 1, wherein the providing step comprises providing the channel comprising a dedicated channel.

11. A wireless communication system comprising:
a channel provided between stations, the channel being divided in slots for carrying data symbols, and
means for inserting power control symbols carrying information associated with one power control command in at least two slots.

12. The wireless communication system according to claim 11, wherein the channel is capable of operating in a discontinuous mode of operation.

13. The wireless communication system according to claim 11, wherein the means for inserting the power control symbols are configured to insert the power control symbols in consecutive slots.

14. The wireless communication system according to claim 13, wherein the discontinuous mode of operation comprises a gated mode.

15. The wireless communication system according to claim 14, wherein the gated mode is even ½^{m} gated transmission, where m is a non-negative integer.

16. The wireless communication system according to claim 15, wherein the means for inserting the power control symbols are adapted to insert the power control symbols in two slots.

17. The wireless communication system according to claim 14, wherein the gated mode is even 1/g^{m} gated transmission, where g is a non-negative integer greater than or equal to 3 and m is a non-negative integer.

18. The wireless communication system according to claim 17, wherein the means for inserting the power control symbols are adapted to insert the power control symbols in two slots.

19. The wireless communication system according to claim 17, wherein the means for inserting the power control symbols are adapted to insert the power control symbols in g slots.

20. The wireless communication system according to claim 11, wherein the channel comprises a dedicated channel.

21. A wireless communication system comprising:
providing means for providing a channel between stations, the channel being divided in slots for carrying data symbols; and
inserting means for inserting power control symbols carrying information associated with one power control command in at least two slots.
